(19) United States
(12) Patent Application Publication
(10) Pub. No.: US 2017/0000590 A1
(43) Pub. Date: Jan. 5, 2017

(54) DENTAL IMPLANT

(71) Applicant: HÜRZELER ZUHR GMBH, München (DE)

(72) Inventor: Markusü HÜZELER, München (DE)

(21) Appl. No.: 15/106,665

(22) PCT Filed: Nov. 7, 2014
(86) PCT No.: PCT/EP2014/074014

§ 371 Date: Jun. 20, 2016

(30) Foreign Application Priority Data
Dec. 20, 2013 (DE) 10 2013 021 934.5

(51) Int. Cl. A61C 8/00

(52) U.S. Cl. CPC A61C 8/0075; A61C 8/0078; A61C 8/0025

(57) ABSTRACT

The invention relates to a one-piece endosseous dental implant with an improved transitional area between the implant and the abutment.

The invention relates to a one-piece endosseous dental implant with an improved transitional area between the implant and the abutment.

Dental implants can be inserted into the jaw bone such that their top edge lines up flush with the bone, or ends above it within the area of the gums covering it.

The dental crown anchored in the implant is usually screwed into the implant by means of an intermediate piece or spacer element, the so-called abutment, in the sense of an anchor-screw connection (anchor=implant, screw=abutment). This abutment has the same diameter as the implant, so that the edges are lined up at the interface.

During the first months after the implant has been implanted, the jaw bone looses about 1 mm due to bone resorption in the interface area. This is attributed, among other things, to the fact that there is a clearance between the implant and the abutment in which bacteria can proliferate (Zipprich et al., 2007). Likewise, numerous studies (Atieh et al., 2010) have shown that it has a positive effect on bone preservation if the abutment has a smaller diameter than the implant, meaning that the abutment is not matched to the outer edge of the implant (“platform matching” principle) but shifted towards the centre, so that it lies further inwards (“platform switching” principle—Canullo et al., 2011; Khurana et al., 2011). This moves the implant abutment interface further away from the surrounding bone, allowing for a better growth of bone and gingival tissue.

The invention is based on the problem that there is an unavoidable micro-gap in the area of the implant-abutment-interface that forms a retention space for bacteria. By placing this micro-gap immediately above the bone, the bone is continuously exposed to contamination and bacteria. As a result, in the course of the natural reconstruction processes taking place at the implant shoulder (=top edge) after an implant has been inserted x-rays reveal a resorption process which can be attributed, among other things, to the bacterial contamination coming from the gap.

This invention solves the problem through the one-piece endosseous dental implant defined in claim 1.

Advantageous and/or preferred embodiments of the invention are covered in the subordinate claims.

The solution according to the invention consists in moving the implant-abutment-interface by, for example, 1.25 mm in a coronal direction, which is achieved through two modifications in the form of the implant in the area of the implant shoulder. On one hand, the implant according to the invention does not end flush with the bone but extends, for example, 3.25 mm beyond the bone, meaning that it has a “head section”. That way, the bacteria-infested gap is moved upwards, away from the bone. On the other hand, the diameter of the implant is reduced by, for example, 1 mm (or the radius by 0.5 mm) at the level of the bone, i.e. it centrally shifted (inwards) in order to reduce the pressure on the bone in this area.

The main advantage gained by means of the invention is that the effect of the reduced-diameter abutment can still be used with a tight connection at the bone level in the implant shoulder area while at the same time there is no gap in the area where the implant emerges from the bone.

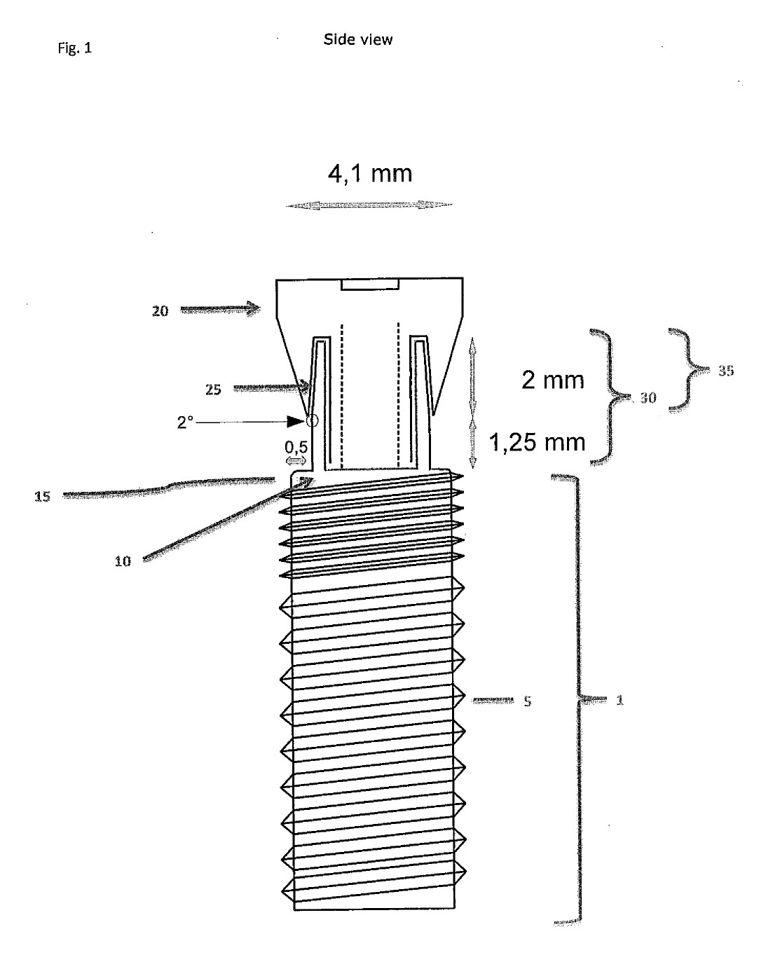

FIG. 1 is a lateral view of an embodiment of the dental implant according to the invention.

A list of reference numerals is provided at the end of the description.

The description is described in further detail in the following without having any limiting effect and merely for illustration purposes.

The implant can, for example, be made with a diameter of 4.1 and 5.1 mm and with a length of 6.5, 8.0, 9.5, 11.0, 12.5 and 14.0 mm. These are standard dimensions that can be found in every product range. Of course there are fundamentally no particular restrictions with regard to the dimensions and proportions of the implants, and the person skilled in the art will adapt these in accordance with the practical requirements.

The implant according to the invention can be made of any material commonly used for the production of implants, for example titanium or ceramic materials. Titanium has the advantage that its elasticity module is similar to that of bone.

Moreover, it is biologically neutral (bio-compatible) and does not trigger any allergic reactions or reactions to foreign bodies. This is due to the fact that titanium is able to form a direct molecular bond with the bone. The portion of the implant that lies within the bone benefits from having a sandblasted and etched surface, a so-called “SLA” surface (SLA=“Sandblasting with Large grit followed by Acid etching”). The result of the SLA treatment is a macro-roughness of the (titanium) surface, thanks to which the bone cells can bond more easily with the implant.

The number of external threads of the implant benefits from rising in the upper area (so-called progressive thread design). According to the invention, the diameter is reduced by, for example, 1 mm in the area where it emerges from the bone (=“platform switch”). In the area of the following, for example, 1.25 mm, the diameter remains the same and has a circular shape. In the next, for example, 2 mm, it is reduced slightly at an angle of, for example, 1-2° and takes the shape of a hexagon. Switching from the circular shape to the hexagonal shape creates a space or rim of, for example, up to 2 mm for the abutment.

During the healing phase, a cover screw (“healing abutment”) can be screwed on. This healing abutment is, for example, 3.5 mm high in total, and about 4.0, 5.0 or 6.0 mm wide, and its exterior walls can, for example, form a 15° or 30° degree angle toward the implant axis. The healing abutment is screwed into the interior thread on the inside of the implant with a screw having a diameter of, for example, 1.2 or 1.8 mm, just like later on the definitive restoration. The geometry of the implant-abutment interface allows for a great variability in the exit profile of the definitive element. The benefit of this is that the same implant design can be used for all regions, which simplifies the clinical process.

FIG. 1 shows an example of an implant according to the invention. The pin-shaped externally threaded body 1, which is screwed into the jawbone, has a length of, for example, 11 mm and a diameter of, for example, 4.1 mm. The exterior thread is identified by reference numeral 5. In the upper portion, the progressive thread design with an increasing number of turns can be seen. At the level of the jawbone (the bone level being identified by the reference numeral 15), the diameter of the implant is reduced by 1 mm (or its radius is reduced by 0.5 mm on both sides), i.e. centrally shifted inwards (=“platform switch”), which is marked with the reference numeral 10. The head section 30 is an integral part of the one-piece implant and protrudes from the jawbone after it has been screwed in. At the bone level 15, the diameter of the head section 30 is coronally constant with a circular shape in the following, for example, 1.25 mm, and in the then following, for example, 2 mm, the diameter is reduced at an angle of, for example, 1-2° towards the implant axis and has a hexagonal shape. Reducing the diameter and switching from the circular shape to the hexagonal shape creates a space or rim (marked with reference numeral 25) of, for example, 2 mm each for the abutment. This is where the unavoidable micro-gap develops when the abutment is attached.

In this example, the implant is fitted with a healing abutment (20) having a diameter of, for example, 4.5 mm, i.e., the outer edges of the implant and of the healing abutment or of the abutment are flush and do not comprise a “platform switch”. The healing abutment is, for example, 3.5 mm high and 4.5 mm wide, and its exterior walls can, for example, form a 15° or 30° degree angle toward the implant axis.

In this example, the bacteria-infested micro-gap between the implant and the abutment is shifted in a coronal direction and is now located, for example, 1.25 mm above the level of the jawbone 15.

The person skilled in the art will of course understand that numerous functionally similar and equivalent variations and modifications of the implant described above by way of an example are possible without leaving the area protected under the patent claims.

### LIST OF REFERENCE NUMERALS

1 pin-shaped externally threaded body

5 external thread

10 “platform switching” of the head section

15 level of the bone

20 healing abutment

25 space for the abutment

30 head section

35 area of the head section in which the diameter is reduced in coronal direction

### LITERATURE

Atieh, M. A., Ibrahim, H. M. & Atieh, A. H. (2010) Platform switching for marginal bone preservation around dental implants: a systematic review and meta-analysis. 3 Periodontol 81, 1350-1366. doi: 10.1902/jop.2010.100232.

Canullo, L., Pace, F., Coelho, P., Sciubba, E. & Vozza, I. (2011) The influence of platform switching on the biomechanical aspects of the implant-abutment system. A three dimensional finite element study. Med Oral Patol Oral Cir Bucal 16, e852-856.

Khurana, P., Sharma, A. & Sodhi, K. K. (2011) Influence of Fine Threads and Platform-Switching on Crestal Bone Stress around Implant—A Three Dimensional Finite Element Analysis. 3 Oral Implantol. doi:10.1563/AAID-JOI-D-10-00148.

Zipprich, H., Weigl, P., Lange, B., Lauer, H. C. (2007) Erfassung, Ursachen and Folgen von Mikrobewegungen am Implantat-Abutment-Interface. Implantologie 15 (1), 31-46.

1. One-piece endosseous dental implant with a pin-shaped externally threaded body (1) for screwing into a jawbone, comprising, at the coronal end of the implant, an abutment in platform switching design allowing for a superstructure to be fastened to it, the externally threaded body (1) having a head section (30) at the coronal end that protrudes from the jawbone after being screwed in, characterized in that the diameter of the head section (30) is smaller than the diameter of the externally threaded body in the area (10) where it emerges from the bone (15), remains constant with a circular shape in the following 1.25 mm, and is reduced at an angle of 1-2 ° towards the implant axis in the following 2 mm, the head section (30) taking on the shape of a hexagon in the process.

2. Dental implant according to claim 1, characterized in that the diameter of the head section (30) at the site where it emerges from the bone (15) is 0.2 to 2 mm smaller than the diameter of the externally threaded body (1).

3. Dental implant according to claim 2, characterized in that the diameter of the head section (30) at the site where it emerges from the bone (15) is 0.2, 0.5, 0.8, 1, 1.5 or 2 mm smaller than the diameter of the externally threaded body (1).

4. Dental implant according to claim 1, characterized in that the head section (30) has a height of 1 to 4 mm.

5. Dental implant according to claim 4, characterized in that the head section (30) has a height of 1, 1.5, 2, 2.5, 3, 3.5 or 4 mm.

6. Dental implant according to claim 1, characterized in that the number of screw threads (5) of the externally threaded body (1) increases in the upper area.

7. Dental implant according to claim 1, characterized in that the abutment is fastened by being screwed to the implant.

8. Dental implant according to claim 1, characterized in that the superstructure is chosen from crowns, and anchors for bridges and prostheses.

9. Dental implant according to claim 1, characterized in that the superstructure is fastened by being screwed, cemented or glued to the abutment.
